(19) United States
(12) Patent Application Publication
(10) Pub. No.: US 2004/0145986 A1
(43) Pub. Date: Jul. 29, 2004

(54) System for monitoring production of optical disk, disk manufacturing methods and authentication method for optical disks, and optical disks

(76) Inventor: Robert Wayne Taylor, Naldhon Pathorn (TH)

Correspondence Address: LUEDEKA, NEELY & GRAHAM, P.C., P O BOX 1871, KNOXVILLE, TN, 37901, US

(21) Appl. No.: 10/250,776

(22) PCT Filed: Jan. 8, 2002
(86) PCT No.: PCT/EP02/00111

(30) Foreign Application Priority Data
Jan. 9, 2001 (GB) 0100528.9

(51) Int. Cl. G11B 7/28

(52) U.S. Cl. 369/53.1; 369/84

(57) ABSTRACT

The present invention provides (with reference to FIG. 1) a monitoring system for monitoring production of optical disks by replication machines (14) at a number of different production facilities (12,13,30,31,32). The system has a central computer (18) which records the production activity of all of the monitored replication machines (14) for central monitoring in order to identify production of unauthorised disks. the invention also teaches how a master stamper can include an identifier code which can be used to identify unauthorised copies. The invention further teaches how local monitoring of replication machines (14) can be conducted in order to determine the number of copies produced by the machines (14). The invention additionally provides a method in which a signature code is recorded on a master stamper and fingerprint information derived from content on the master stamper. The signature code and the fingerprint information are stored together on a . An optical disk can be authenticated by reading from it a recorded signature code and deriving fingerprint information for the recorded content and then consulting the database.

This invention relates to optical disks. It also relates to manufacturing methods for optical disks, a monitoring system for monitoring production of optical disks and a system for checking the authenticity of optical disks.

Optical disks commonly on sale include audio CDs, DVDs and CD roms. Approximately 8 billion legitimate optical disks are produced each year. It is estimated that 2.5 billion optical disks are fraudulently produced from the same factories producing legitimate disks and also from secret “pirate” factories. This equates to $18 billion lost to fraud.

In the production of optical disks first of all laser beam recorders are used to produce master stampers. The master stampers are then used by replication machines to produce the actual optical disks for sale. The master stampers function as mould tools in an injection moulding process, in which a disk is formed with a surface defined by a surface of the master stamper, the disk is then metallised and a lacquer is applied over the metallised surface.

There are two major ways in which pirating occurs. First of all, although for instance 10,000 from a master stamper have been authorised, 15,000 may be produced with the extra 5,000 being sold illegitimately. Similarly individual tracks from an optical disk may be copied to produce a compilation although no authorisation from the intellectual property right holder has been given.

Unfortunately, it is currently very difficult to obtain evidence to persuade a court to convict someone of pirating.

The present invention provides in a first aspect a monitoring system for monitoring production of optical disks by a plurality of optical disk replication machines located physically remote from each other at a plurality of production facilities, the monitoring system comprising:

sensor means associated with each replicating machine for sensing how many optical disks are produced by the replication machine;

local computer apparatus individual to each production facility which receives signals from the sensor means associated with each replication machine of the production facility, the local computer apparatus processing and storing at least temporarily data derived from the received signals; and

central computer apparatus receiving via a telecommunications network signals from each local computer apparatus of each production facility and processing and storing centrally data derived from the received signals; wherein:

the central computer apparatus creates a record of production activity of all of the optical disk replication machines to allow the production of the replication machines to be analysed centrally.

The present invention provides in a second aspect a method of producing a master stamper for subsequent use by a replication machine in the production of optical disks, the method including recording on the master stamper an identifier code in the form of signature code for the master stamper, the method including deriving the signature code from a plurality of data including time of creation of the master stamper.

The present invention provides in a third aspect a replication system for producing optical disks which comprises:

a replication machine which replicates content recorded on a master stamper on to optical disks;

an optical disk validator for validating correct replication of recorded content on the optical disks, the validator validating each optical disk by inspecting a surface thereof; and

a conveyor system which conveys for further processing optical disks validated by the validator and which rejects optical disks not validated by the validator; wherein:

a first optical sensor is provided for counting how many optical disks initially have recorded content replicated thereon;

a second optical sensor is provided for counting how many optical disks are rejected by the validator; and

an electronic processor is provided to compare count figures provided by the first and second optical sensors to produce a remainder figure.

The present invention provides in a fourth aspect a method of manufacturing and subsequently authenticating at least one optical disk comprising the steps of:

producing a master stamper for subsequent use by a replication machine in the production of optical disks;

recording on the master stamper an identifier in the form of a signature code for the master stamper;

deriving fingerprint information for content recorded on the master stamper;

storing on a database of computer apparatus a record of the identifier recorded on the master stamper along with a record of the derived fingerprint information for the content recorded on the master stamper;

using the master stamper in a replication machine to produce optical disks carrying both the content and the signature code; and

subsequently authenticating at least one optical disk by:

reading from the optical disk the signature code;

deriving fingerprint information from the content carried by the optical disk; and

consulting the database on the computer apparatus to retrieve the fingerprint information recorded on the database in respect of the signature code read from the optical disk and then comparing the fingerprint information retrieved from the database with the fingerprint information obtained from the optical disk and authenticating the optical disk if there is a match of fingerprint information.

Preferred embodiments of the present invention will now be described with reference to the accompanying figures in which:

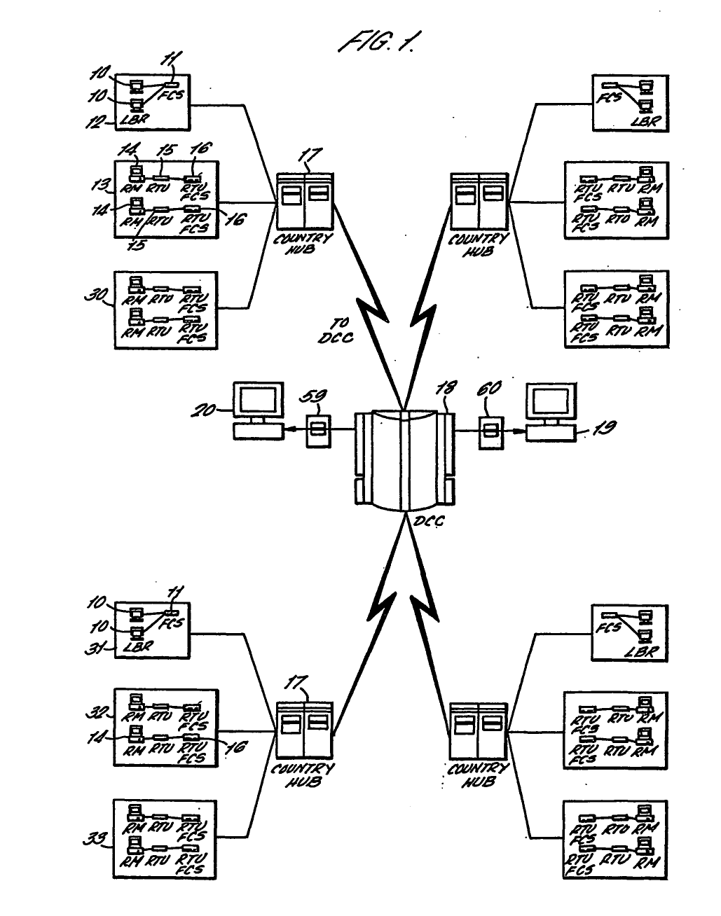

FIG. 1 is schematic overview of a system for monitoring production of optical disks according to the present invention;

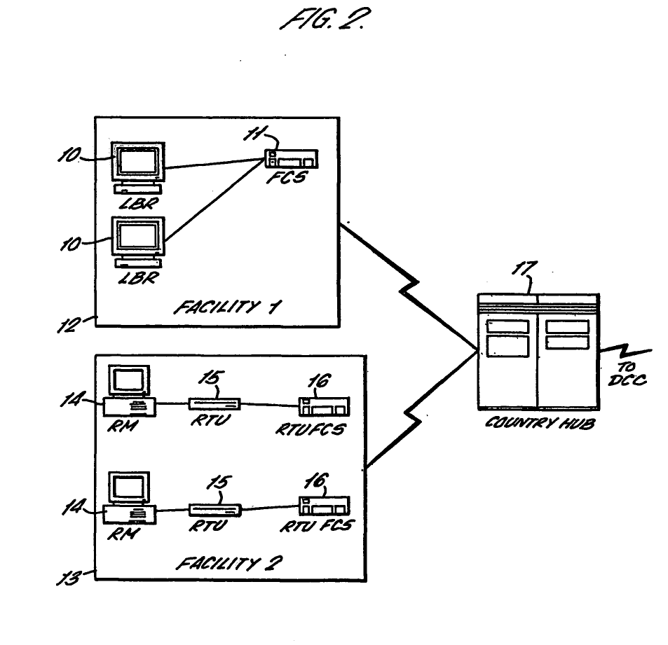

FIG. 2 is a schematic illustration of a part of the monitoring system of FIG. 1;

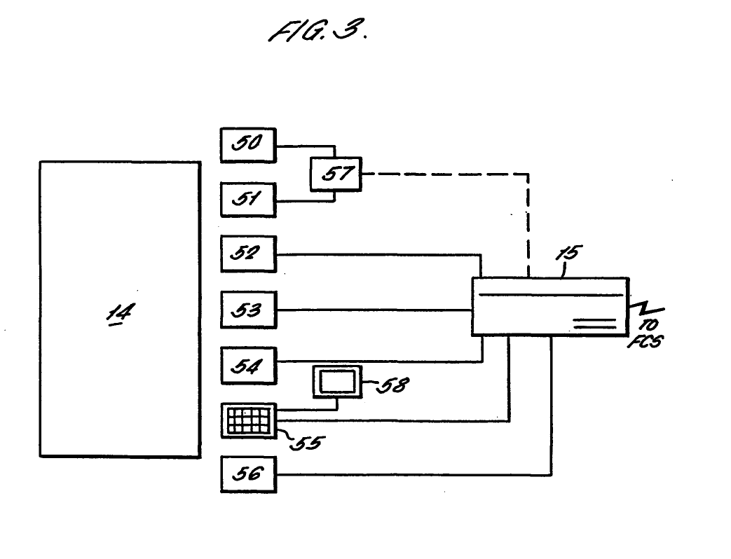

FIG. 3 is a schematic illustration of a part of the monitoring system of FIG. 1;

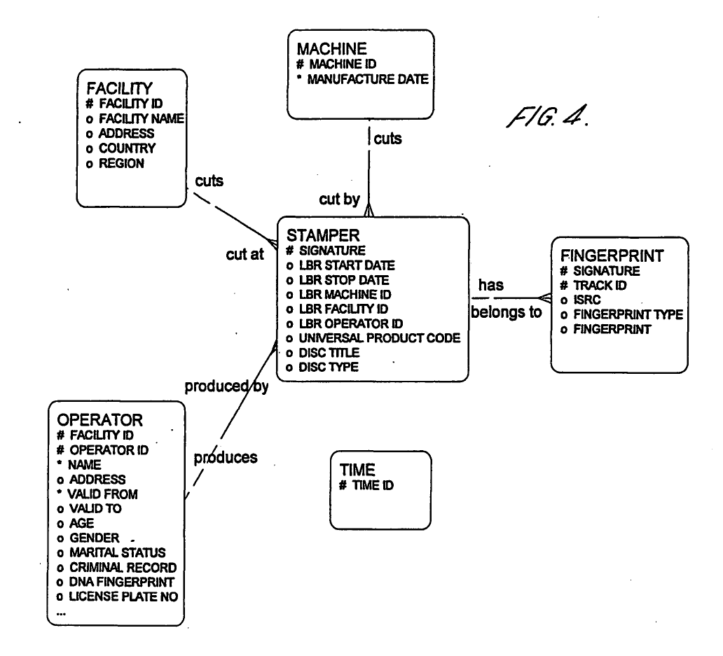

FIG. 4 is a diagram showing information collated during production of a master stamper;

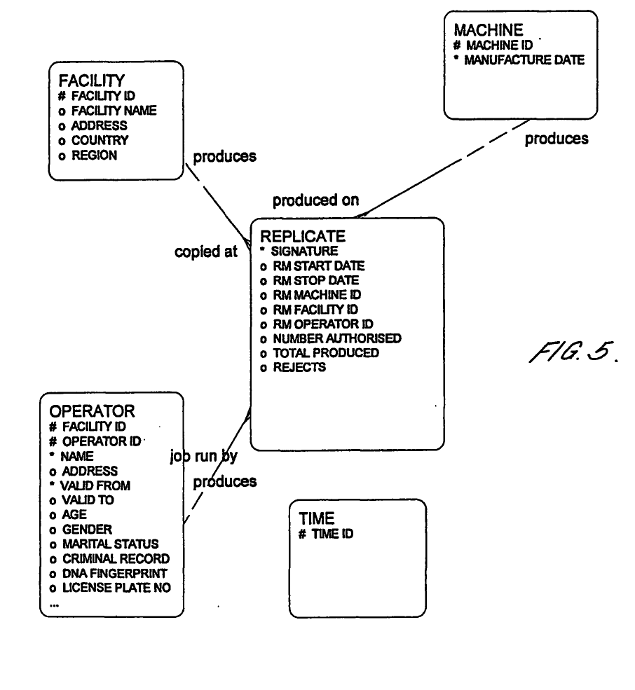

FIG. 5 is a diagram showing information collated during replication; and

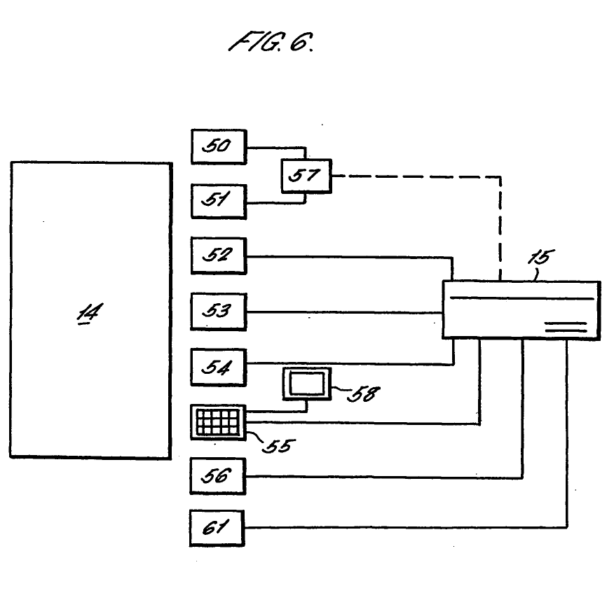

FIG. 6 is a schematic illustration of a part of a second embodiment of monitoring system.

In FIGS. 1 and 2 there can be seen a laser beam recorder 10. The laser beam recorder 10 is part of a mastering system for producing master stampers. As mentioned above, each of the master stampers is then used in replicating machines 14 for the production of optical disks-for sale. In the system of the invention, along with recording content (e.g. music) on the master stampers, there is also on the master stamper a hidden code. The hidden code is generated by a mastering monitoring system which is implemented by installing software alongside the laser beam recorder control application software. This encoded information is then replicated in each optical disk replicated from the master stamper so that the source of the replicated disk can be tracked. This hidden code will be hereinafter referred to as the master-stamper signature code. This will be a unique identifier.

Located near the laser beam recorder will be a file/communication server 11. The information transmitted from the laser beam recorder to the file/communication server 11 would include the date and time of mastering, a master stamper signature, a code for the indicating the operator of the master stamper, a code indicating the facility in which the master stamper is located and information regarding track fingerprints. Track fingerprints are unique identifiers, which identify musical tracks. Each musical track has its own unique fingerprint. The fingerprint is obtained by e.g. sampling the music track according to a set methodology. Fingerprinting is not the subject of the present invention.

Instead of receiving the information from the laser beam recorder, the information could be read from the master stamper by a reader (not shown) and then input to the file/communication server 11. Alternatively, raw electronic data could simultaneously be fed to the laser beam recorder 10 and to electronic apparatus for determining track fingerpints (not shown) which would then send the fingerprint information to the file/communication server 10.

In FIG. 4 there is illustrated the information that is collected by the file communication server 11. The file communications server 11 collects the information regarding the laser beam recording machine 10 such as the machine identification number and the date of manufacture of the machine. The file communication server 11 also collects information regarding the manufacturing facility ( two manufacturing facilities 12 and 13 located in the same country are shown in FIGS. 1 and 2) in which the laser beam recorder 10 is located. Typically, this information will comprise a facility identification number, from which can be identified a facility name and facility address, country and region.

The file communication server 11 also collects fingerprint information which comprises for each track information regarding the track fingerprint and the track identification, the type of fingerprint and also the fingerprint itself. In addition it will record the information from the disk Table of Contracts header and the IRSC (International Standard Recording Code) International coding for the track (if present).

Each laser beam recorder 10 will be operated by a human operator who at the start of the process of creating a master stamper must enter information so that he or she can be identified.

It is envisaged that to increase security each operator may have a password permission that is time-limited and will have to enter the password or personal information to verify authorisation to operate the machinery.

The file/communication server 11 will have an internal clock and the time of creation of each master stamper will also be recorded.

Once a master stamper has been recorded then it will be used subsequently by a replication machine 14 to produce optical disks for distribution and sale. In FIG. 2, replication machines 14 are located at a manufacturing facility 13 which is physically remote from the facility 12. However, it could be that the replication machines and the laser beam recorders are all located at the same manufacturing facility.

Associated with each replication machine 14 there will be a remote terminal unit 15. Each remote terminal unit will take the form of a fully integrated microprocessor unit specifically designed for unattended operations in unconditioned environment with wide temperature ranges, humidity ranges, high electrical noise, high audible noise and high vibration.

As can be seen in FIG. 3, each remote terminal unit 15 will receive input data from a range of sensors including optical sensors 50, 51, proximity sensors 52, 53, an optical disk reader 54, an alphanumeric key pad 55 and a barcode reader 56, the input data being received as serial input data via cables and additionally, or alternatively via a transceiver 57 operating a Bluetooth® system. Bluetooth® is a short-range radio link intended to replace cable connections and connect portable or fixed electronic devices. It is robust, has low complexity, low power and low cost.

The Bluetooth® system provides point to point connection or point to multipoint connection. It will be used to connect e.g. the optical sensors 50,51 with the remote terminal unit 15 (instead of wire connections).

Each remote terminal unit 15 will output data to a remote terminal unit file communication server 16. The connection will typically be a hardwired connection, although Bluetooth® connection is possible.

Optionally, each remote terminal unit 15 will have a port enabling information to be downloaded to a laptop computer via a serial port. Optionally, each remote terminal unit 15 will be connectable to an Ethernet local area network. This will enable e.g. fault diagnosis.

At the start of a replication operation, a replication operator will enter via the alphanumeric keypad 55 a job code, an operator code, a machine code and the total number of optical disks to be pressed. This information will be stored in the remote terminal unit 15 along with the date and time of the start of the job. The alphanumeric keypad 55 will be associated with a screen 58 such as a liquid crystal display screen which will prompt the operator for the required inputs and will display the inputs for verification. The data input by the operator will reset the remote terminal unit's count buffers, job buffers, and close any previous job.

The optical sensor 50 connected to the remote terminal unit 15 will be mounted to count all the compact disks that are moulded by the replicating machine 14 (to give a total count figure). The replicating machine 14 will have a validator which will inspect the recording surface of each replicated optical disk to detect abnormalities. Optical disks with abnormalities will be rejected. The further optical sensor 51 will be mounted to count the number of optical disks rejected by the compact disk reader (the reject count). The total count and the reject count will be accumulated and stored in a memory buffer in the remote terminal unit 15 along with the date and time from a real time clock in the remote terminal unit 15. A special optical disk reader 52 will be connected to each remote terminal unit 15 to read the hidden code from a replicated optical disk. At the beginning of a replication run the operator will remove a validated optical disk from the replicating machine 14 and will place the validated optical disk in the reader 54 which will read the hidden code replicated on the disk. The operator will then be prompted to input using the keyboard 55 the identifier code of the machine 14 from which the disk is taken. The remote terminal unit 15 will record the hidden code and the machine identifier code associated with other recorded data.

The remote terminal unit 15 will compile for each replication job a job information file containing:

1. An operator identifier code

2. A machine identifier code

3. A number of optical disks to be pressed

4. A start time and date of the pressing operation

5. A count of the total number of optical disks replicated

6. A count of the total number of optical disks rejected

7. The hidden code on a replicated optical disk

8. A finish time and date

Each remote terminal unit 15 will have on-board battery backup to power the random access memory and the real time clock during powercuts. The battery backup will be separate from any normal battery backup used in connection with the power supply to the RCU 15.

The remote terminal unit file/communication server 16 will be a self-contained unit designed for unattended operation and remote management. It will be located at or near the replication facility 13. The server 16 will periodically poll the remote terminal unit 15 (or a plurality of remote terminal units 15) assigned to it. It will collect and store data from the respective remote terminal unit(s) 16. It will acknowledge successful transmission of data, it will encrypt data and will buffer the information for subsequent transmission to a country hub server. The file/communications server 16 will also provide for remote management of the remote terminal unit(s) 15 connected thereto and will allow addition of or deletion of remote terminal units with minimum requirement for physical attendance.

FIG. 5 illustrates the file of information that is collected by the server 16 for onward transmission. The optical disk reader 54 connected to the remote terminal unit 15 will read from a replicated optical disk (removed from a replication run by an operator) a signature replicated from a master stamper. Information regarding the signature is collected by the server 16.

A dial-up modem will be integrated with each file server 16 which will allow data communication between file server 16 and a country hub server 17. The modem will require separate dial-up lines independent of installed telephone line for the relevant facility. Files of information collected by the server 16 are periodically transmitted to the country hub server 17 via the telephone line, in encrypted form.

It is envisaged that there will be two types of security for each file server 16. Physical security will be maintained by locating the server either in a locked room or a locked container. Physical access to the server will be allowed only to keyholders. Furthermore, the proximity sensor 52 will be associated with the file server 16 and will provide an alarm signal when the enclosure or container is opened. A second type of security will be password security providing data access security. Each server 16 located in a country will generate files which are forwarded to the country hub server 17 detailing times of access and the user names of the people who have access to the server. This will enable identification of any unauthorised person trying to break into the system to extract data or modify the operating system. The server 16 will be configured with user passwords and security levels of access to different parts of the system. For example, a user who is contracted for maintenance of the data backup devices will be denied the right to access and/or modify any part of the operating system. Data stored will be encrypted to increase security.

The proximity sensor 532 will be associated with one or both of the optical sensors 50, 51 to detect tampering therewith.

The server 16 system will provide for automatic unattended backup of the server hard drive and operating system. Also the server 16 will purge transmitted data from its hard drive as an added precaution against unauthorised access.

A battery backup will power the server 16 during power cuts. This battery backup will be separate from any normal backup used to power the facility. The battery backup will have battery power sufficient to power the server for several hours of normal operation. A signal indicating power outage and an alarm indicating low battery levels will be generated. As a further backup, there will be onboard battery backup to power the RAM memory and the real time clock during power outages. This battery backup will be separate and independent from the unit's battery backup.

The server 16 will generate an audit log which will be transmitted to the country hub server 17. The audit log will contain information regarding server access by users giving user names and passwords with dates and time stamps. The audit log will also contain details of the status of the remote terminal unit(s) 15 connected to the server 16 with any instances where the remote terminal unit(s) 15 is/are offline noted by date and time. Any power outages will be noted with date and time.

The server 16 will keep a communications log which will comprise dates and times of communication with the country hub 17, the size of packets of information transmitted to the country hub 17, the sizes of files transmitted to the country hub 17 and a log of remote management steps taken with details of the name of a user and associated passwords and dates and times.

The country hub server 17 is a unit designed for unattended operation and remote management. It will be located at a secure site. It will periodically poll all file servers 11 and 16 connected to it which will be file servers associated with laser beam recorders 10 and replication machines 14 located at manufacturing facilities throughout a country. The server 17 will accept and store data from the servers 11 and 16 and acknowledge the successful transmission of data, convert the data into an Oracle database, encrypt the data and buffer the information for onward transmission to a data control centre server 18. The country hub server 17 will also allow addition and deletion of connected servers with a minimal requirement for physical attendance.

Each country hub server 17 will typically run local database. Dialup modem racks will be integrated with each country hub server 17 allowing data communications with the connected servers 11 and 16. It is envisaged that the communication between the country hub server 17 and the servers 11 and 16 will take place over a frame relay arrangement or over the Internet using a virtual private network arrangement.

It is also envisaged that permitted users in a country wishing to access the data control centre server 18 will dial up the country hub server 17 for the territory and access the data control centre server 18 via the country hub server 17.

There will be two types of security provided for each country hub server 17. Physical security will be maintained by locating the server either in a locked room or in a locked container. Access security will be restricted to passwords. In addition, a country hub server 17 generated report will be forwarded to the data control centre server 17 detailing times of access and the user names of person who have accessed the country hub server 17. This will enable identification of any unauthorised attempt to access the server.

The country hub server 17 will be configured with user passwords and security levels for access to different parts of the system. This will enhance the security of the machine and strictly define the areas that any given user can have access to. For example, a remote user who has access to access certain files at the data control centre server 18 through the country hub server 17 will be denied the right to access or modify any part of the data stored by the country hub server 17. Stored data will be encrypted where possible.

The system will provide for automatic unattended backup of the hard drive of the country hub server 17 and its operating system. Additionally, the country hub server 17 will purge from the hard drive any data, which has been transmitted onward to the data control centre 18.

A UPS battery backup system will power the country hub server 17 during power outages. The UPS will be separate from any normal backup used to power the host site. It will be equipped with software to automatically close and open files and shut down the system at the end of the battery life.

The country hub server 17 will generate an audit log, which will be transmitted to the data control centre server 18. The audit log will contain the following information:

1. Details of access by users with reference to the user name/password and dates and times of access

2. Status of the server with offline dates and times

3. Details of power outages with dates and times

4. A log of communications comprising dates and times of communications with the servers connected to the laser beam recorders and to the replication machines

5. Dates and times for communication with the data control centre server 18

6. Details of the packet sizes of the transmissions to the data control centre server 18

7. Details of the sizes of files transmitted to the data control centre-server 18

8. Logs of remote management activities with the user names/passwords and dates and times

For any remote accesses to a country hub server 11 there will be details of telephone numbers (if caller IDs or identification is available), the password used, packet size used and the connection speed along with any details of error messages and the date and time of the start of the connection and the end of the connection.

The data control centre server 18 receives online information from every country hub server 17 in the monitoring system and consolidates the data into a central database. This can be seen in FIG. 1 where the manufacturing facilities 12, 13 and 30 are all located in a first country and each have a server 11 connected to a laser beam recorder 10 or a server 16 connected to a replication machine 14 and where the manufacturing facilities 31, 32, 33 are located in a second country and again each have a server 11 connected to a laser beam recorder 10 or a server 16 connected to a replication machine 14. Each country has its own country hub server 17 and all the country hub servers 17 relay information to the data control centre server 18. The central database of the data central centre server 18 will contain up to the minute information on mastering and pressing operations worldwide.

The data control centre server 18 performs an important function in addition to collecting and storing raw data on production. It is an antipiracy centre. Through data analysis the server 18 can spot potential pirating activities around the world. A large number of pirated copies are produced in legitimate facilities through the illegal activities of a few unscrupulous individuals. By analysing production patterns, illegal or suspect activity can be spotted and, individual operators or shifts can be targeted for further investigation. If and when such activity results in a court case, documentation from the system will be invaluable in obtaining convictions of the person/s involved.

The information stored in the data control centre server 18 also provides information extracts for various music industry associations (worldwide production figures, sales volumes etc). This is represented in FIG. 1 by the connection to a computer 19, which is representative of a computer used by a music industry association.

The data stored on the data control centre server 18 is also used by owners of the copyright in the content recorded on the optical disks, which is represented in FIG. 1 by the computer 20 which is used by an IP right holder. The IP right holder can use computer to access the information on the database stored on the server 18 in order to obtain information on the production of products embodying the holder's content.

The data control centre server 18 could comprise a plurality of servers. For instance, a plurality of Solaris servers with Unix operating systems could be used to support an Oracle database. The architecture of the data control centre server 18 will comprise an Internet information server which is the first linked server in the architecture. This will be the gateway for communications with the central database server, the country hub servers 17 and the remote users such as the IP rights holder using computer 20 and the industry association using the computer 19.

Dialup modem racks will be integrated in the data control centre server arrangement and these will allow data communications with the country hub server 17 via frame relay arrangement or a virtual private network run on the Internet. Additional lines will also allow remote users to dial up the data control centre through a proxy request server. Proxy request servers 59 and 60 are shown-in FIG. 1.

There will be two types of security provided for the data control centre server. Physical security will be maintained by locating the server in a controlled access facility. Access to the facility will be controlled e.g. by electronic door locks and additional access control at workstations, with additional access control protection for workstations.

Remote access security will be implemented through the use of firewalls, proxy request servers 59 and 60 and user passwords. In addition, the data control centre server 18 will generate a report which will be stored on the server or printed out, detailing the times of access and the user name of the person that has accessed the data. This will allow detection of unauthorised accesses.

The data control centre server 18 will use standard technology to enable identification of network users, servers, applications etc. Authentication protocols such as Radius will be used. Also, digital certificates, smartcards and directory services can be used.

Routers, switches with access control lists and/or state of the art files will all be used to protect the server 18.

The system will provide an automatic unattended backup of the hard drives of the server 18 and its operating system. An automatic UPS battery backup system will provide the server with power during power outages. The UPS will be separate from any normal backup used to power the site. It will also be equipped with software to automatically close open files and shut down the system at the end of the battery life.

The data control centre server 18 will generate an audit log which will be stored or printed. The audit log will contain information regarding direct access by users, identifying the users by their names, passwords and date and time of access. The log will also contain details of system status with offline dates and times for each part of the system. Power outages will also be logged by date and time in each part of the system. The communications log will contain data on the date and time of communication with the country hub server 17, the dates and times of communications with remote users e.g. 19 and 20, packet size transmitted to the data control centre, the packet size downloaded from the data control centre to remote users, e.g. 19 and 20. The size of the files transmitted to the data control centre server 18 and a log of remote management activities with the names of users and their passwords and dates and times of access.

The data control centre server 18 will periodically poll the country hub servers 17 in order to retrieve data from them. The data will be stored on an Oracle server. The server 18 will acknowledge completion of data transfer to it. The server 18 will collate and sort the data it receives.

From the above, it will be appreciated that this system has several inbuilt alarms to warn of tampering. Each remote terminal unit 15 has signals indicating power failure, breach of the physical enclosure, failure to enter correct passwords, failure of communication link, tampering with the sensors connected to the remote terminal unit and a temperature alarm. Each file/communications server 11 and 16 (both for the replicating machines and the laser beam recorders) will have alarm signals indicating a power failure, tampering with the physical enclosure in which the server is located, failure to enter a correct password, failure of communications, an excess temperature alarm and an alert regarding a computer virus. Each country hub server 17 will have alarm signals indicating power failure, a breach of the physical enclosure incorporating the server, a failure to enter a correct password, a failure of communication, an excess temperature of an alert relating to a computer virus. The data control centre server 18 will have alarm signals generated indicating a power failure, a failure to enter a correct password, a failure of communication, an excess temperature, a computer virus, a violation of physical access to the server and a violation of dialup access to the server. Thus tampering and interference can be easily spotted and dealt with.

From the above it will be appreciated that the system allows collection in the central database of information regarding creation of a master stamper and then the production of optical disks from the master stamper. As mentioned above, a unique signature code is hidden on the master stamper and this unique signature code is then replicated by a replicating machine in the optical disks. Information supplied from the laser beam recorders 10 and the associated file/communication servers 11 will supply the database with a record for each master stamper of a signature code associated with the fingerprint data for the tracks which are recorded on the master stamper. Considering musical tracks, the fingerprint information will be extracted via an algorithm from each musical track. For instance, the algorithm could choose 100 points of comparison in the track and use this as a track identifier. The direct association of a signature with fingerprints of tracks enables detection of illegal optical disks, because for each signature code found an investigator can determine from the database of the data control centre server 18 what tracks should be on the relevant optical disks.

The first step in an antipiracy campaign would be to look to see whether an optical disk had a signature at all. If there is no signature on the disk then there will be a deduction that it is an illegal copy. It will be appreciated that the signature will be hidden on the part of the disk that is not usually used and the code will be short.

Field enforcement personnel would use optical disk readers to check in the field whether an optical disk has a hidden signature and to determine the fingerprints of the tracks recorded on the optical disk. They would then use the central data base on server 18 to identify from the read signature which master stamper is relevant and then which replicator facilities are relevant. Then they could identify Intellectual Property ownership of the tracks by comparing the fingerprints of the tracks with information stored on the central database. This information can be used to ensure that licences have been granted for each track and royalty fees obtained. Also if a legal action is needed the Intellectual Property Rights holder can be identified for the legal action.

In the present invention the unique signature is time-specific to the creation of the master stamper. This is a novel way of approaching the encoding of information on the master stamper.

The single hidden signature can give details of when, where and who made the master stamper along with the information regarding the musical tracks. Associated with the signature there will also be information regarding the operator of the machine creating the master stamper.

The database will also contain information relating each master stamper to subsequent replication operations.

The monitoring of the replication machine will allow identification of illegal activities. It is envisaged that the owner of musical rights will only entrust production of optical disks to factories which have the monitoring system in place. Once the monitoring system is in place then the production runs can be monitored and any unusual activities identified. For instance, the sensors associated with the remote terminal units will be able to devise/derive a rate of production of compact disks. If there is an unusual rate of production then an alert can be notified to the administering authority who can investigate further. Furthermore, if the sensors connected to the remote terminal unit indicate that for a particular run of CDs, the total time taken appears to be too long then again an alert can be indicated. Furthermore, if there are unusual changes in patterns of operation when certain operators are using the replicating machines then this again could indicate illegal activity and would be investigated. Operation of the machines at unusual start times could be investigated.

It is envisaged that the central server 18 will periodically provide information regarding production runs to the holders of Intellectual Property Rights (e.g. record companies). The holders of the Intellectual Property Rights will input to the central database fingerprint information for each track to be reproduced. Thus the fingerprint information received from the optical disk readers associated with the replication machines would be used by the central server to identify which tracks are being replicated. Also the hidden signature code read by the optical disk readers would identify the master stampers from which the optical disks are being replicated. Therefore the Intellectual Property Rights holders can be provided electronically with information regarding how many optical disks are being replicated with particular tracks at which production facilities and from which master stampers. This information can then be checked with the records of licences held by the Intellectual Property Rights holders to ensure that the reported production runs have been authorised.

Over time the central server will build up a history of the average rate of reproduction of each track. If the information received by the central server indicates a significantly increased rate of production then an alert can be sent electronically to the relevant Intellectual Property Rights holder. This can be analysed by replication machine and by operator so that if a particular machine is regularly used to replicate unpopular tracks or if a particular operator is regularly responsible for a production of unpopular tracks then an alert can be issued. Unusually high production runs for unpopular tracks would indicate that an operator is trying to fool the monitoring system by informing the system that the unpopular track is being replicated whilst in reality replicating a popular track.

The Intellectual Property Rights holders (e.g. record or software companies) can input sales figures of optical disks into the database of the central server. Then the central server would compare the total production recorded for an optical disk against recorded sales. Where there is a discrepancy an alert can be issued.

The central server can over time build up an average production pattern (in terms of length of production runs, rate of production, changeover periods) for each production facility. Exceptional production patterns can then be alerted for subsequent closer investigation.

The central server will be programmed to consider the reject rates of each replication machine. Unusually high reject rates will trigger an alert.

The central server will be programmed to consider the replication rate of each machine. Typically a disk will take 3 to 5 seconds to produce. Significant deviations from such a production rate will cause the central server to issue an alert.

The central server will be programmed to consider how long each replication machine is inactive whilst the master stamper is changed. Any unusually long period will cause the central server to issue an alert.

An improvement to the system described above could be achieved by adding to the replication machine a further reader 61 (see FIG. 6) which reads a visible bar code provided at the centre of each optical disk. Such visible bar codes are commonly provided as identifiers on optical disks. The reader would read the bar code and send a signal to a local remote terminal unit 15. The information provided by this signal would be compared with the information provided by the optical disk reader 54 to ensure that the identity of the optical disk placed in the reader 54 identifying the replicated disks in a particular replication run is the same as the identity of the optical disks replaced on the replication machine during the same replication run.

The database of the central server will typically comprise at least two separate databases, a first production database which stores information received from the master stamper production machines and the replication machines and a second database entering identification information received from Intellectual Property Rights holders providing them with fingerprints of trades.

Any tampering with the monitoring system would be alerted in the way mentioned above.

At present it is envisaged that external sensors will be used attached to the replicating machines, but in future these sensors could be incorporated in the replicating machines themselves. In fact, this could be simply done by modifying operating systems software rather than the attachment of new hardware. In this case the monitoring system could be improved by adding an authorisation function. The Intellectual Property Rights holders could input to a database held by the central server authorisation information regarding what replication runs have been authorised. Before each replication run the software on a replication machine would interrogate the database to determine whether the run is authorised. Unauthorised replication would not be allowed by the software. The central server would send an alert to the relevant Intellectual Property holder(s) asking for authorisation on an exceptional basis. Replication would be permitted only if such exceptional authorisation is received.

1. A monitoring system for monitoring production of optical disks by a plurality of optical disk replication machines located physically remote from each other at a plurality of production facilities, the monitoring system comprising:
sensor means associated with each replicating machine for sensing how many optical disks are produced by the replication machine;
local computer apparatus individual to each production facility which receives signals from the sensor means associated with each replication machine of the production facility, the local computer apparatus processing and storing at least temporarily data derived from the received signals; and
central computer apparatus receiving via a telecommunications network signals from each local computer apparatus of each production facility and processing and storing centrally data derived from the received signals; wherein:
the central computer apparatus creates a record of production activity of all of the optical disk replication machines to allow the production of the replication machines to be analysed centrally.

2. A monitoring system as claimed in claim 1 wherein:
the sensor means associated with each replication machine comprises:
a first counter which counts total production of optical disks by the replication machine; and
a second counter which counts the number of optical disks rejected by the replication machine.

3. A monitoring system as claimed in claim 2 wherein the first and second counters are optical devices.

4. A monitoring system as claimed in any one of the preceding claims comprising additionally:
manually operable input means associated with each replication machine and connected to the local computer apparatus of each replication machine; wherein:
the manually operable input means allows the input of operator identification information which identifies the human operator of the replication machine;
the local computer apparatus relays to the central computer apparatus received information regarding human operators of each replication machine at the relevant production facility; and
the central computer apparatus stores in respect of each recorded production run the identity or identities of the human operator or operators of the replication machine during the production run.

5. A monitoring system as claimed in any one of the preceding claims wherein timing means is provided associated with each local computer apparatus whereby the local computer apparatus can record the start times and finish times of production runs of the replication machines.

6. A monitoring system as claimed in claim 5 wherein the local computer apparatus determines a rate of production from the start times and finish times of the production runs and from the recorded numbers of optical disks;
information regarding the rate of production is sent to central computer apparatus and the central computer apparatus monitors whether the reported rates of production are within usual ranges and reports exceptions to a system administrator.

7. A monitoring system as claimed in any one of the preceding claims, wherein the sensor means have associated therewith tampering detection means which detects tampering with the sensor means and provides signals indicating tampering to the local computer apparatus, the local computer apparatus passing records of sensed tampering on to the central computer apparatus.

8. A monitoring system as claimed in any one of the preceding claims wherein each local computer apparatus is located in a physically secure container and tamper detection means is provided associated with each physically secure container, the tamper detection means providing signals indicating tampering with the relevant container and the local computer apparatus receiving the signals and relaying the signals to the central computer apparatus.

9. A monitoring system as claimed in any one of the preceding claims wherein each replication machine uses a master stamper in the replication process and the monitoring system additionally monitors production of master stampers by a plurality of physically remote master stamper production machines at a plurality of master stamper production facilities, the monitoring system comprising additionally:
local computer apparatus connected to each master stamper production machine at a master stamper production facility which local computer apparatus receives signals from the master stamper production machine which include information regarding a signature code recorded on the master stamper, the local computer apparatus relaying details regarding the signature code to the central computer apparatus; and
an optical disk reader is associated with each replication machine, the optical disk reader reading a signature code from one or more optical disks produced by each replication machine, the signature code recorded on each optical disk having been replicated from a master stamper; wherein:
the local computer apparatus associated with each replication machine relays to the central computer apparatus details of the signature code read by the optical disk reader associated with the replication machine; and
the central computer apparatus records information regarding signature codes received thereby.

10. A monitoring system as claimed in claim 9 wherein each master stamper production machine relays to the local computer apparatus associated therewith fingerprint information regarding content recorded on the master stamper and the local computer apparatus relays the fingerprint information to the central computer apparatus along with the signature codes and the control computer apparatus records which fingerprint information is associated with each signature code.

11. A method of authentication of an optical disk replicated from a master stamper produced by a master stamper production machine monitored by the monitoring system of claim 10, the method of authentication comprising using an optical disk reader to read a signature code on an optical disk being authenticated and using the information stored by the central computer apparatus to determine what fingerprint information is recorded in respect of the signature code by the central computer apparatus, the determined fingerprint information being then compared with fingerprint information obtained directly from the optical disk being authenticated.

12. A method of producing a master stamper for subsequent use by a replication machine in the production of optical disks, the method including recording on the master stamper an identifier in the form of a signature code for the master stamper, the method including deriving the signature code from a plurality of data including time of creation of the master stamper.

13. A method of producing a master stamper as claimed in claim 12 wherein the data used in the derivation of the signature code additionally includes an identification code for the master stamper machine.

14. A method of producing a master stamper as claimed in claim 12 or claim 13 wherein the data used in the derivation of the signature code additionally includes an identification code for the production facility in which the master stamper production machine is located.

15. A method of producing a master stamper as claimed in any one of claims 12 to 14 wherein the data used in the derivation of the signature code additionally includes an identification code for the human operator using the master stamper production machine.

16. A method of producing a master stamper as claimed in any one of claims 12 to 15 wherein the data used in the derivation of the signature information additionally includes data identifying content recorded on the master stamper.

17. A method of producing a master stamper as claimed in any one of claims 1 to 16 wherein the signature code of each master stamper is stored in a computer database.

18. An optical disk manufactured by a replication machine from a master stamper produced by a method as claimed in claim 17.

19. An authentication method for authenticating the origin of the optical disk claimed in claim 18, the method comprising using an optical disk reader to read from the optical disk the signature code recorded thereon and consulting the computer database to determine the origin of the optical disk by accessing information stored in association with the signature information.

20. A replication system for producing optical disks which comprises:
a replication machine which replicates content recorded on a master stamper on to optical disks;
an optical disk validator for validating correct replication of recorded content on the optical disks, the validator validating each optical disk by inspecting a surface thereof; and
a conveyor system which conveys for further processing optical disks validated by the validator and which rejects optical disks with content not validated by the validator; wherein:
a first optical sensor is provided for counting how many optical disks initially have recorded content replicated thereon;
a second optical sensor is provided for counting how many optical disks are rejected by the validator; and
an electronic processor is provided to compare count figures provided by the first and second optical sensors to produce a remainder figure.

21. A replication system as claimed in claim 20 wherein the electronic processor comprises timing means and calculates a rate of production of optical disks from the signals received from the optical sensor and timing information provided by the timing means.

22. A replication system as claimed in claim 20 or 21 wherein the system comprises additionally an optical disk reader which reads a signature code stored on an optical disk produced by the replication machine and which relays the signature code via a telecommunications network to a computer database on which the signature code is stored.

23. A replication system as claimed in claim 22 wherein the optical disk reader additionally samples information read from the optical disk to determine therefrom one or more fingerprints for the track(s) recorded on the optical disk and the optical disk reader relays the fingerprint(s) via the telecommunications network to the computer database.

24. A replication system as claimed in claim 22 or claim 23 comprising additionally a visible code reader for reading a visible code provided on the surface of one or more of the replicated optical disks as the replicated optical disks pass through or from the replication machine, the visible code reader providing identification information and the replication system comprising comparator means which compares identification information provided by the signature code with the identification information provided by the visible code reader to determine whether the replicated optical disks passing through or from the replication machine have the same identity as the optical disk read by the optical disk reader.

25. A replication system as claimed in any one of claims 20 to 24 comprising additionally manually operable input means operable by an operator which can be used to send information regarding the reproduction operation via a telecommunications network to a computer database on which the operation information is stored.

26. Use of a computer apparatus as local computer apparatus in a monitoring system as claimed in any one of claims 1 to 10.

27. Use of a computer apparatus as control computer apparatus in a monitoring system as claimed in any one of claims 1 to 10.

28. A method of manufacturing and subsequently authenticating at least one optical disk comprising the steps of:
producing a master stamper for subsequent use by a replication machine in the production of optical disks;
recording on the master stamper an identifier in the form of a signature code for the master stamper;
deriving fingerprint information for content recorded on the master stamper;
storing on a database of computer apparatus a record of the identifier recorded on the master stamper along with a record of the derived fingerprint information for the content recorded on the master stamper;
using the master stamper in a replication machine to produce optical disks carrying both the content and the signature code; and
subsequently authenticating at least one optical disk by:
reading from the optical disk the signature code;
deriving fingerprint information from the content carried by the optical disk; and
consulting the database on the computer apparatus to retrieve the fingerprint information recorded on the database in respect of the signature code read from the optical disk and then comparing the fingerprint information retrieved from the database with the fingerprint information obtained from the optical disk and authenticating the optical disk if there is a match of fingerprint information.

29. An optical disk manufactured by the replication machine in the method of claim 28.

30. Use of computer apparatus to store the database in the method of claim 28.
